(19) United States
(12) Patent Application Publication
(10) Pub. No.: US 2013/0067456 A1
(43) Pub. Date: Mar. 14, 2013

(54) APPLICATION CONFIGURATION FRAMEWORK FOR ENTERPRISE RESOURCE PLANNING APPLICATION INSTALLATION

(71) Applicants: Sanidhya Khilnani, Sunnyvale, CA (US); Manoj Swaminathan, Issaquah, WA (US); Choon Chea Chua, Seattle, WA (US)

(72) Inventors: Sanidhya Khilnani, Sunnyvale, CA (US); Manoj Swaminathan, Issaquah, WA (US); Choon Chea Chua, Seattle, WA (US)

(73) Assignee: MICROSOFT CORPORATION, Redmond, WA (US)

(21) Appl. No.: 13/230,762

(22) Filed: Sep. 12, 2011

(51) Int. Cl. G06F 9/445

(52) U.S. Cl. 717/174

(57) ABSTRACT

A configuration application utilizes an application configuration framework to create a configuration questionnaire to dynamically manage an enterprise resource planning (ERP) application installation process. The configuration application imports an ERP system's metadata to configure the ERP application installation through the application configuration framework. The configuration application requests question parameters from a configuring user to configure the ERP application installation according to the metadata. Subsequently, the configuration application creates a configuration questionnaire for the ERP application installation based on the question parameters.

### BACKGROUND

Enterprise resource planning (ERP) systems integrate organizational information management. ERP systems automate information flow across platforms and organizational environments. ERP systems provide integrated solutions to finance, manufacturing, sales, and customer relationship management environments. ERP systems include some common characteristics such as integrated solutions functioning in real time, with a common database, consistent user interface elements, and common installation and configuration components. Common characteristics simplify information technology department processes for installation and management. Additionally, integrated ERP system solutions are deployed with a high level of customization and features to meet customer requirements. As a result, ERP system solutions have high installation costs but save the customer costs in the long run through their integrated features.

Current ERP systems are not tailored to easily meet customer requirements. Modern, ERP systems require significant customer specific customizations before deployment in an enterprise environment. Customizations include configuring feature specific parameters, populating reference data tables and master data tables, etc. Feature rich customizations require significant time and investment from an ERP application installer. To minimize customizations, some ERP systems provide setup wizards or initialization checklists. Most wizards and checklists are static in nature and require programmatic changes for feature specific setup information at customer deployment.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to employing an application configuration framework to create a configuration questionnaire for configuring an enterprise resource planning (ERP) application installation. A configuration application utilizing the application configuration framework may import ERP system metadata for configuration. The configuration application may request question parameters to configure the ERP application installation based on the ERP metadata. The configuration application may receive the parameters as answers to the questions. The configuration application may create an ERP application installation configuration questionnaire based on the question parameters.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a networked environment, where a configuration application may deploy an application configuration framework to create a configuration questionnaire to configure an ERP application installation according to some embodiments;

FIG. 2 illustrates components of a system developing a configuration questionnaire to configure the ERP application installation;

FIG. 3 illustrates the metadata importer component of the application configuration framework and the framework's subcomponents;

FIG. 4 illustrates the questionnaire creator component of the application configuration framework and the framework's subcomponents;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process creating a configuration questionnaire to configure an ERP application installation utilizing the application configuration framework according to embodiments.

### DETAILED DESCRIPTION

As briefly described above a configuration application may utilize an application configuration framework to create an enterprise resource planning (ERP) system configurator. The configurator may be in the form of a questionnaire or wizard to be deployed during ERP system configuration. The configuration application may start building the questionnaire by importing ERP system metadata to be used for configuring the ERP application installation. The metadata may include ERP system components and component settings. Subsequently, the configuration application may request question parameters to configure the ERP application installation based on the ERP system metadata. The question parameters may span a variety of information to be determined in order to build the configuration questionnaire. The information may cover action and default behavior. Upon receiving the question parameters, the configuration application may create the configuration questionnaire based on the question parameters. The resulting configuration questionnaire may be deployed during the ERP application installation. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, a floppy disk, or a compact disk, and comparable media.

ERP applications span a variety of application environments that provide solutions to business demands. ERP applications may provide tools for finance/accounting, human resources, manufacturing, supply chain management, project management, customer relationship management, data services, access control, etc. Configuration questionnaire for the ERP application installation may be a series of questions in a questionnaire format. The configuration questionnaire may be presented in a wizard format. The configuration questionnaire may capture variety of installation details including target ERP application installation parameters.

Throughout this specification, the term “platform” may be a combination of software and hardware components for employing an application configuration framework to create an ERP application installation configuration questionnaire. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

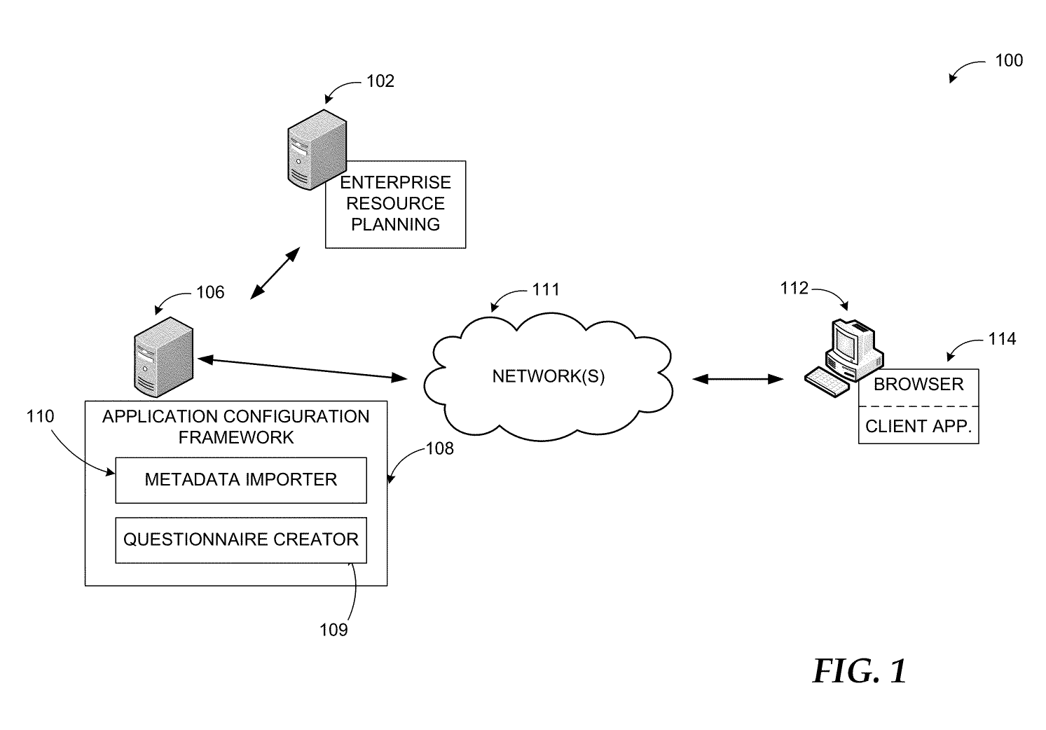

Referring to FIG. 1, diagram 100 illustrates a networked environment, where a configuration application utilizing an application configuration framework may create a configuration questionnaire for an ERP application installation according to question parameters provided by a configuration application according to some embodiments. The computing devices and computing environments shown in diagram 100 are for illustration purposes. Embodiments may be implemented in various local, networked, and similar computing environments employing a variety of computing devices and systems.

In an example environment illustrated in diagram 100, a client application 114 (e.g. a browser) executed on client device 112 may display a user interface (UI) to access an application configuration framework 108 executed on server 106 within an configuration application execution environment providing (among other things) a metadata importer 110 and a questionnaire creator 109. A user (regardless of expertise) may access the application configuration framework 108 through the UI displayed by the client application 114. The user may provide question parameters through the client application 114. The client application 114 may be running in a web browser, or on a smartphone, slate, or similar device. Client application 114 and the application configuration framework 108, metadata importer 110 and questionnaire creator 109 may communicate over one or more networks such as network(s) 111, which may be secure or insecure, enterprise, public, wired, wireless, cellular, etc. Furthermore, data associated with the ERP system processes, ERP system components and etc. may be stored locally or at an externally within the ERP system 102, for example.

The user may access the application configuration framework 108 to build a configuration questionnaire for an ERP application installation. The user may build the configuration questionnaire to enable dynamic ERP application installation. The configuration questionnaire may be shared with co-workers, collaborators, etc. The metadata importer 110 may retrieve component settings of an ERP system, such as default ERP application deployment or a master ERP application provider, from which questionnaire creator 109 may customize the question parameters to be requested from the user.

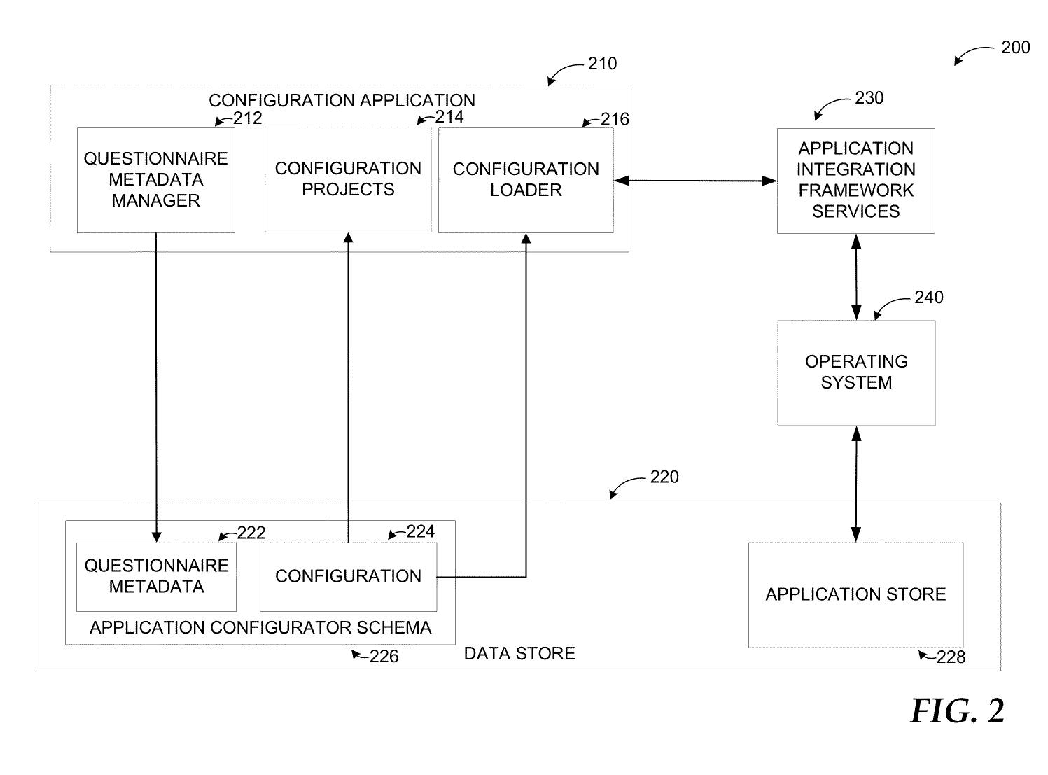

FIG. 2 illustrates components of a system developing a questionnaire to configure an ERP application installation. Diagram 200 displays a schema of a configuration application utilizing the application configuration framework. The configuration application 210 may be browser based. It may utilize the application configuration framework to manage multiple components. The questionnaire metadata manager 212 component may retrieve and maintain configuration questionnaire metadata 222. The configuration questionnaire metadata 222 may be retrieved by the metadata importer component of the application configuration framework from the application configuration schema 226 contained by data store 220. Data store 220 may be a database maintained by the ERP system to house the ERP data and configuration.

Configuration components configuration projects 214 and configuration loader 216 may be controlled by the questionnaire creator component of the application configuration framework. The configuration components may retrieve settings from configuration schema 224 from the data store 220 and create question parameters to ask the user.

After building the configuration questionnaire, the client application may interact with application integration framework services 230 to instantiate the installation of ERP application. The ERP application installation may be managed through an operating system 240 and stored in application store 228 which may be managed by the data store 220. An example scenario may be ERP system data store managing the configuration questionnaire for the ERP application installation.

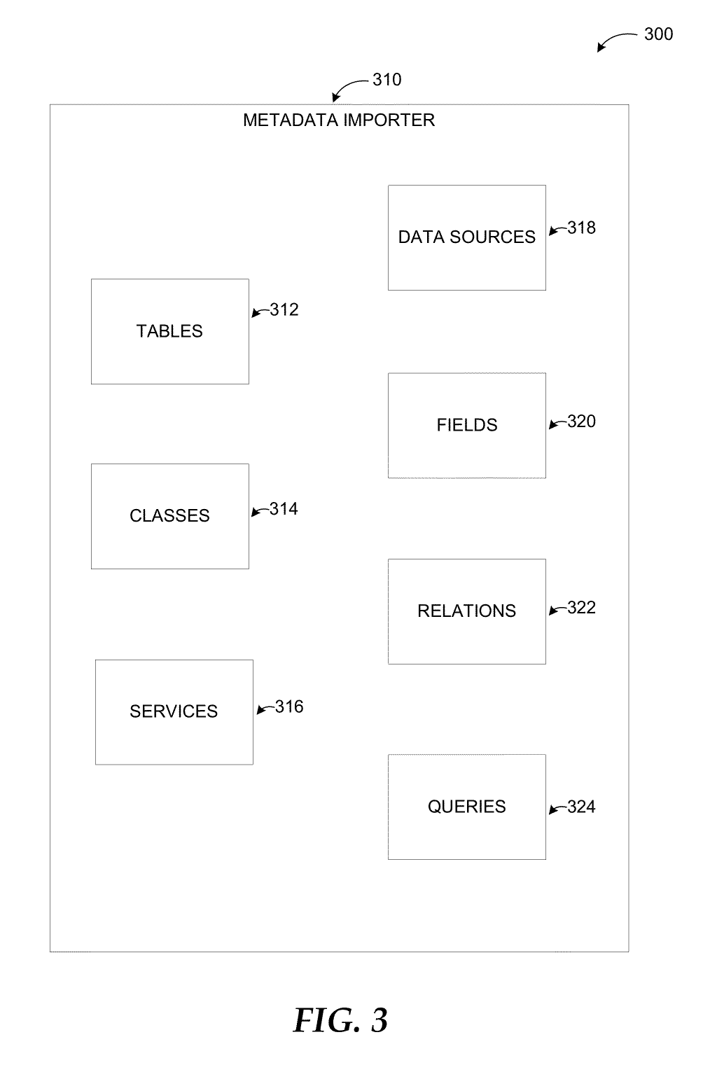

FIG. 3 illustrates the metadata importer component of the application configuration framework and the framework's subcomponents. Diagram 300 displays entities in an ERP system that may be configured during an installation. An ERP system configuration schema or settings may expose what entities may need to be configured during ERP application installation. The metadata importer 310 may access the ERP system and retrieve information for the exposed entities for subsequent installation.

The metadata importer 310 may retrieve configuration information of the ERP system entities such as tables 312, classes 314, services 316, data sources 318, fields 320, relations 322, queries 324, etc. For tables 312, the metadata importer may retrieve the table schema with which may be used to customize question parameters such as table names and column names and column data types to be utilized in the ERP application installation. The metadata importer may provide the table parameters from existing schema or enable new values to be added by information provided by the ERP system.

In another scenario, the metadata importer may retrieve and present parameters of classes 314 from the ERP system. The classes 314 parameters such as available class names, and structures may be used to customize question parameters. Additionally, the question parameters may be customized by available services 316 names and their descriptions. The question parameters may also be customized by available data sources names.

The question parameters may also be customized by fields 320 names and descriptions including data types to be stored with the fields 320. The question parameters may further be customized by relations 322 parameters such as dependencies and relationship types. Dependencies may include foreign key relationships. Relationship types may include one to many, many to one, many to many relationship types. Furthermore, queries 324 parameters may be used to customize question parameters when presenting which available queries to utilize during installation. The question parameters may also be customized using query descriptions.

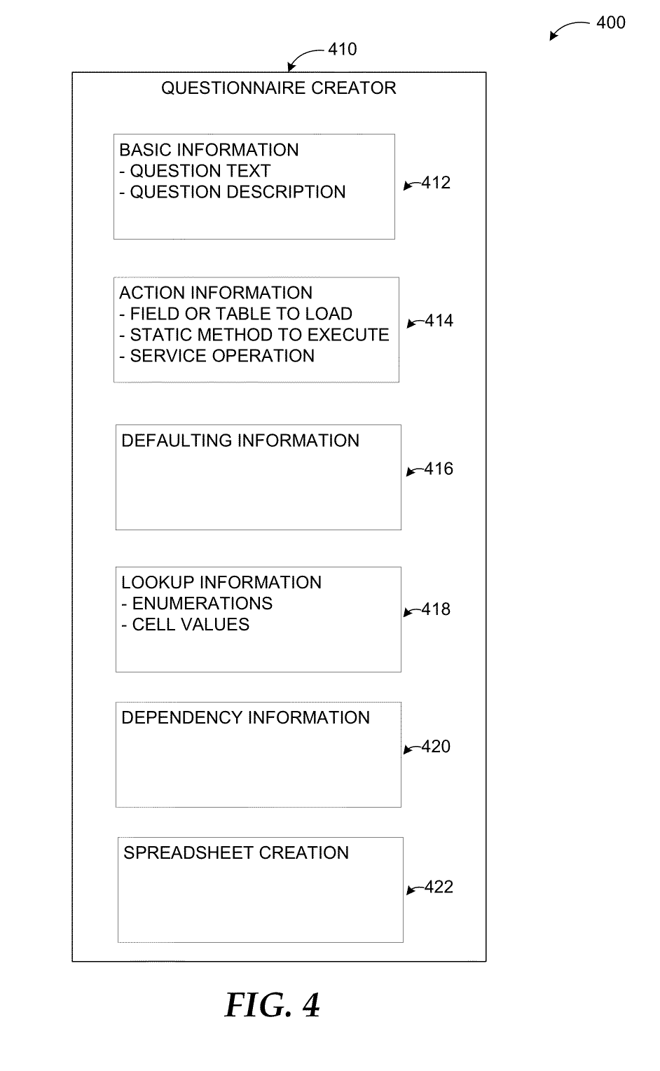

FIG. 4 illustrates the questionnaire creator component of the application configuration framework and the framework's subcomponents. Diagram 400 displays categories of question parameters that the questionnaire creator 410 may retrieve from a user. Question parameters may be customized according to the ERP system metadata provided by the metadata importer as discussed above.

Questionnaire creator 410 may retrieve, from configuring user, basic information 412 about the installation questions to be asked an installer during the ERP application installation. The basic information 412 may include question text and question description. Questionnaire creator 410 may also retrieve action information to be asked a user during the installation. The action information 414 may include a field, a table, a static method, and a service operation of the ERP system to load during the ERP application installation.

Additionally, the questionnaire creator 410 may retrieve defaulting information 416. Defaulting information 416 may be predetermined values to populate configuration questionnaire during installation upon an installer's inaction to populate the configuration questionnaire.

Alternatively, the questionnaire creator 410 may retrieve lookup information 418. The lookup information 418 may include enumerations containing selectable predetermined values to populate answers to questions within the configuration questionnaire. The lookup information 418 may also include cell values such as a range of data to populate a spreadsheet cell.

In another embodiment, the questionnaire creator 410 may retrieve dependency information 420. Dependency information 420 may determine selection of question series based on answers to previous questions.

In yet another embodiment, the questionnaire creator 410 may enable spreadsheet creation 422 for data entry. The questionnaire creator may provide data tables and fields of the ERP system for populating the spreadsheet as well as enable manual data entry to generate data entities for the ERP application installation process. The questionnaire creator 410 may generate the configuration questionnaire and provide the configuration questionnaire as a wizard based interactive tool to be employed during the ERP application installation.

The example scenarios and schemas in FIGS. 2 and 4 are shown with specific components, data types, and configurations. Embodiments are not limited to systems according to these example configurations. Employing an application configuration framework to generate a configuration questionnaire to configure an ERP application installation may be implemented in configurations employing fewer or additional components in applications and user interfaces. Furthermore, the example schema and components shown in FIGS. 2 and 4 and their subcomponents may be implemented in a similar manner with other values using the principles described herein.

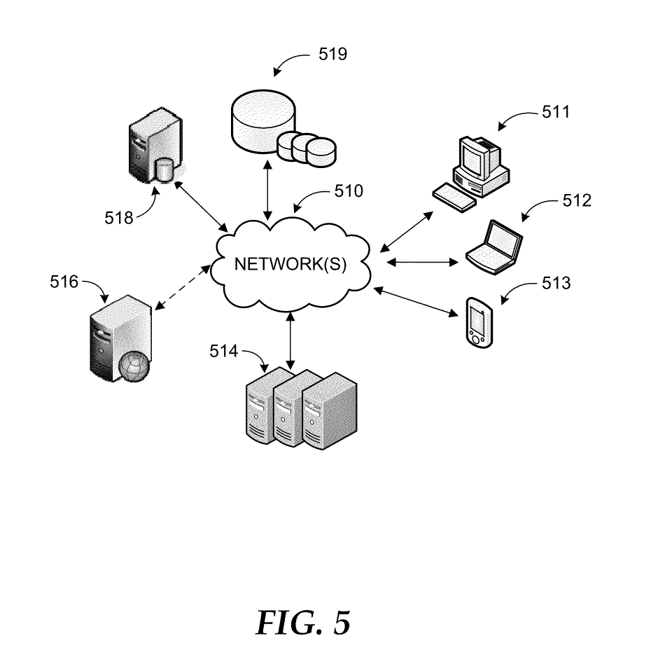

FIG. 5 is a networked environment, where a system according to embodiments may be implemented. A configuration questionnaire may be created by a configuration application employing an application configuration framework over one or more servers 514 or a single server (e.g. web server) 516 such as a hosted service. The application configuration framework may communicate with client applications on individual computing devices such as a smart phone 513, a laptop computer 512, or desktop computer 511 (‘client devices’) through network(s) 510.

As discussed above, a configuration questionnaire may be created by a configuration application utilizing an application configuration framework using customized question parameters according to metadata imported from the ERP system. The ERP system schema may provide parameters for questions for configuring entities during EPR application installation.

Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to create a configuration questionnaire using an application configuration framework. Furthermore, the networked environments discussed in FIG. 5 are for illustration purposes only. Embodiments are not limited to the example applications, modules, or processes.

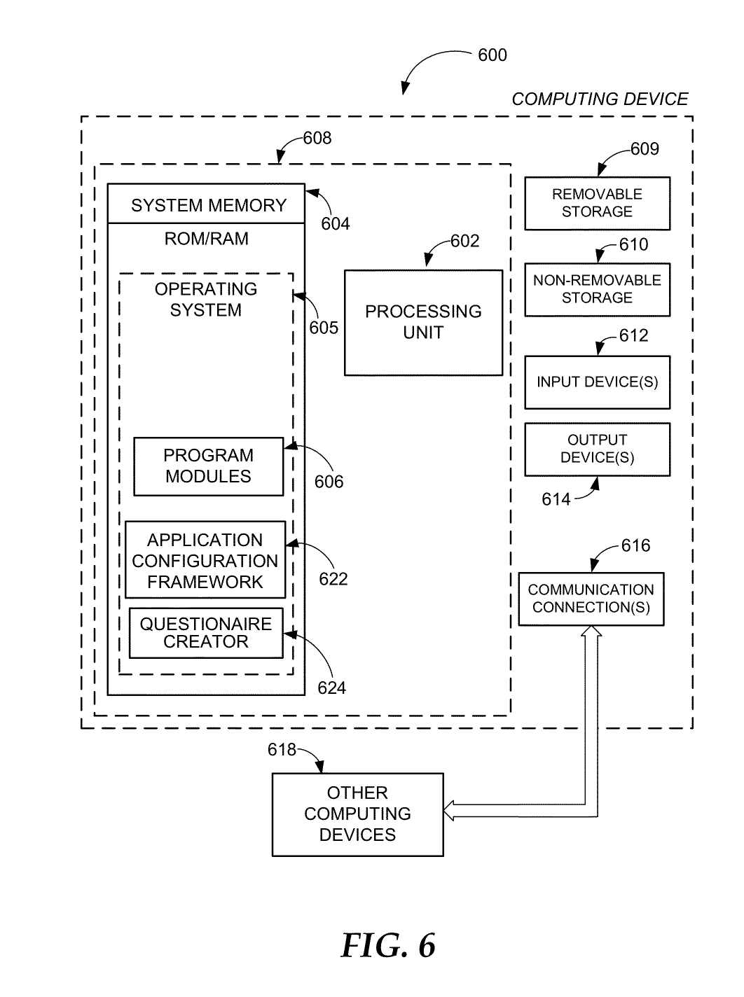

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, application configuration framework 622, and questionnaire creator 624.

Application configuration framework 622 may be part of a configuration application determining question parameters for a configuration questionnaire to be presented to an installer of a ERP application during installation. The questionnaire creator 624 may customize question parameters according to imported metadata. The questionnaire creator 624 may also request question parameters from a user and create a configuration questionnaire for deployment during installation of the ERP application. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

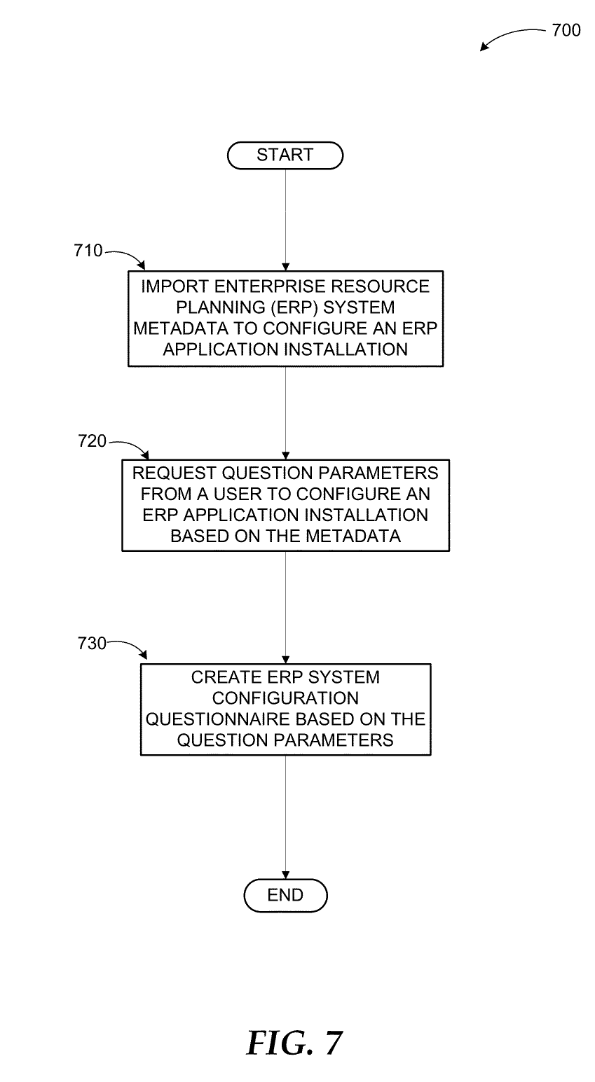

FIG. 7 illustrates a logic flow diagram for a process creating a questionnaire to configure an ERP application installation utilizing the application configuration framework according to embodiments. Process 700 may be implemented by a configuration application employing an application configuration framework in some examples.

Process 700 may begin with importing ERP system metadata to configure an ERP application installation at operation 710. The imported metadata may include standard schemas of available ERP system features, applications and components. A questionnaire configurator may request question parameters to configure the ERP application installation based on the ERP metadata at operation 720. The questionnaire configurator may customize the question parameters based on the ERP system metadata. At operation 730 the questionnaire configurator may create configuration questionnaire for the ERP application installation based on the question parameters. The configuration questionnaire may be used at install time in a wizard based presentation.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Employing an application configuration framework for configure an installation process of an ERP system may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for employing an application configuration framework to configure an enterprise resource planning (ERP) application at installation, the method comprising:
importing a metadata of an ERP system to configure installation of an ERP application;
requesting question parameters from a configuring user to configure the installation of the ERP application according to the metadata; and
creating a configuration questionnaire for the installation of the ERP application based on the question parameters.

2. The method of claim 1, wherein the metadata includes at least one from a set of: basic information, action information, defaulting information, lookup information, and dependency information.

3. The method of claim 2, wherein the basic information includes question text and question description to be presented to an installer during the installation of the ERP application.

4. The method of claim 2, wherein the action information includes at least one from a set of:
a field, a table, a static method, and a service operation of the ERP system to load during the installation of the ERP application.

5. The method of claim 2, wherein the defaulting information includes predetermined values to populate the configuration questionnaire upon an installer's inaction to populate the configuration questionnaire during the installation of the ERP application.

6. The method of claim 2, wherein the lookup information includes limits for values of answers to the configuration questionnaire.

7. The method of claim 6, wherein the limits for the values of the answers include one of enumerations in the ERP system and cell values from a spreadsheet-column used to answer a previous question.

8. The method of claim 2, wherein the dependency information defines a set of questions to be presented based one or more answers to previously presented questions.

9. The method of claim 1, further comprising:
creating a spreadsheet for data entry to generate data entities of the ERP application during the installation of the ERP application.

10. The method of claim 9, wherein the spreadsheet is further enabled to be populated with at least one from a set of: manual data entry and selectable data entities of the ERP system.

11. A computing device for employing an application configuration framework to configure an enterprise resource planning (ERP) application at installation, the computing device comprising:
a memory storing instructions; and
a processor coupled to the memory, the processor executing a configuration application in conjunction with the instructions stored in the memory, wherein the configuration application is adapted to:
import a metadata of an ERP system to configure an installation of an ERP application;
request question parameters from a configuring user to configure the installation of the ERP application based on the metadata;
retrieve from the metadata at least one from a set of: basic information, action information, defaulting information, lookup information, and dependency information; and
create a configuration questionnaire for the installation of the ERP application based on the question parameters and the retrieved information.

12. The computing device of claim 11, further adapted to:
customize the question parameters using at least one from a set of: tables, classes, services, data sources, fields, relations, and queries from the metadata.

13. The computing device of claim 12, wherein the tables include table schemas comprising table names, table column names, and column data types.

14. The computing device of claim 12, wherein the classes include at least one from a set of:
class names and class structures.

15. The computing device of claim 12, wherein the relations include dependencies and relationship types of at least one from a set of one to many, many to one, and many to many.

16. A computer-readable memory device with instructions stored thereon for employing an application configuration framework to configure an enterprise resource planning (ERP) application at installation, the instructions comprising:
importing a metadata of an ERP system to configure an installation of an ERP application;
requesting question parameters from a configuring user to configure the installation of the ERP application based on the metadata;
customizing the question parameters using at least one from a set of: tables, classes, services, data sources, fields, relations, and queries from the metadata;
retrieving from the metadata at least one from a set of: basic information, action information, defaulting information, lookup information, and dependency information; and
creating a configuration questionnaire for the installation of the ERP application based on the customized question parameters and the metadata. Attorney Docket No. 333564.01

17. The computer-readable memory device of claim 16, wherein the instructions further comprise:
employing the configuration questionnaire for re-configuration subsequent to the installation of the ERP application.

18. The computer-readable memory device of claim 17, wherein the instructions further comprise:
persisting at least a portion of answers to the configuration questionnaire for the re-configuration subsequent to the installation of the ERP application.

19. The computer-readable memory device of claim 16, wherein the instructions further comprise:
mirroring the configuration for a plurality of ERP application installations.

20. The computer-readable memory device of claim 16, further comprising:
managing the configuration questionnaire in a data store of the ERP system.
